(19) United States
(12) Patent Application Publication
(10) Pub. No.: US 2006/0131356 A1
(43) Pub. Date: Jun. 22, 2006

(54) Adhesive tape cutter

(75) Inventor: Toshiaki Imazeki, Sanbu-gun (JP)

Correspondence Address: GREENBLUM & BERNSTEIN, P.L.C., 1950 ROLAND CLARKE PLACE, RESTON, VA, 20191, US

(73) Assignee: CPC Co., Ltd., Chiba-ken (JP)

(21) Appl. No.: 11/029,344

(22) Filed: Jan. 6, 2005

(30) Foreign Application Priority Data
Dec. 20, 2004 (JP) 2004-367954

(51) Int. Cl. B26F 3/02

(52) U.S. Cl. 225/6

(57) ABSTRACT

An adhesive tape cutter that can automatically form a tab to make it easier to peel off adhesive tape attached to an object and enables a user to unwind the adhesive tape smoothly is obtained. The adhesive tape includes: a tape-supporting member 11 for supporting a wound body of adhesive tape 13 in such a manner that the wound body of adhesive tape 13 can rotate; a cutting member 30 for cutting an adhesive tape 12 drawn from the wound body 13 supported by the tape-supporting member 11; and an overlapping-area-forming mechanism 20 located between the tape-supporting member 11 and the cutting member 30 to form an overlapping area 12C of the adhesive tape 12 by folding under margin 12E along the lengthwise direction of a specified width of the adhesive tape 12 toward its adhesive surface 12A side.

### BACKGROUND

The present invention relates to a tape cutter that forms a non-adhesive area of adhesive tape, drawn from a wound body of adhesive tape, by folding under a side edge of the adhesive tape along its lengthwise direction to cause the adhesive surfaces of the tape to stick together, thereby making it easier to peel off the adhesive tape once it is attached to an object.

Adhesive tape is made by applying an adhesive agent containing rubber or synthetic resin as its principal component onto one side of a long thin-film base material of, for example, cloth, cellophane, kraft paper, rubber, or polyvinyl chloride. This adhesive tape is generally wound into a roll and is distributed as a wound body of adhesive tape. The adhesive tape is used for various adhesion purposes, for example, sealing the covers of envelopes, bags, or boxes.

When such adhesive tape is used, it is drawn from the wound body of adhesive tape and is cut to a desired length. A tape cutter is used to make it easier to perform the above operation. The tape cutter includes: a tape holder for supporting the wound body of adhesive tape in such a manner that the wound body can rotate; and a cutting member for cutting the adhesive tape drawn from the wound body. Accordingly, the tape cutter can easily cut the adhesive tape, which is pulled out to a desired length, without using any tool such as scissors or a cutter knife, and can attach the adhesive tape to an object.

Adhesive tape is used for various adhesion purposes, and is often used for the purpose of temporary binding. Adhesive tape used for such temporary binding is later either torn or cut off. Since the base material of the adhesive tape is thin and the adhesive agent is applied to the entire one side of the base material, it is difficult and cumbersome to peel off the adhesive tape attached to an object. Specifically speaking, in order to peel off adhesive tape where the entire adhesive surface is stuck to an object, it is necessary to form a tab by, for example, scratching the adhesive tape with finger nails or the like to cause the end of the adhesive tape to stick up, and to then pull the tab to peel off the adhesive tape. This process of scratching and forming a tab is very cumbersome and annoying.

For example, commercially available boxed meals or prepared foods are usually packed in food packing containers and placed on sale at shops. Adhesive tape of width in excess of 10 mm is often used to seal the cover of the containers or to attach a seasoning bag, which contains seasoning such as sauce or dressing, to the outside surface of the food packing container. With a conventional food packing container packaged using the adhesive tape as described above, the entire surface of the adhesive tape is attached to the food packing container. Therefore, when a consumer tries to open the cover of the container or to remove a seasoning bag, it is very difficult and annoying to peel off the adhesive tape.

Lately, in order to make it easier to peel off the adhesive tape, an adhesive tape cutter has been introduced that can, when pulling out the adhesive tape from a wound body of adhesive tape, automatically form a non-adhesive area that will constitute a tab along a side edge of the adhesive tape in its lengthwise direction, by folding a margin of the adhesive tape under and causing the adhesive surfaces to be placed facing and stuck to each other (for example, see Japanese Patent Laid-Open (Kokai) Publication No. 2001-302078 and Japanese Laid-Open (Kokai) Publication No. 2004-315203).

### SUMMARY

However, the adhesive tape cutter described in Japanese Patent Laid-Open (Kokai) Publication No. 2001-302078 is structured in such a manner that a closing member, that is located above a delivery path of the adhesive tape and freely opens or closes to cover the delivery path, swings on the rotation axis of the delivery roller closest to a tape-supporting member. Accordingly, there is the problem of the inability to completely largely open the full length of the insertion path of the adhesive tape. Therefore, it is particularly difficult to insert the adhesive tape into the area below the delivery roller. It is also necessary to bend and insert the edge of the pulled-out adhesive tape between a fold-starting roller and a side-folding guide, and this operation is also very difficult.

The adhesive tape cutter described in Japanese Patent Laid-Open (Kokai) Publication No. 2004-315203 is structured in such a manner that an overlapping area constituting a non-adhesive area is formed along at least one margin of the adhesive tape in its lengthwise direction, and the overlapping area is made by inserting and pulling out the adhesive tape between an adhesive-surface-side member that faces the adhesive surface of the adhesive tape, and a non-adhesive-surface-side member that faces the non-adhesive surface of the adhesive tape, making the adhesive tape in contact with and pressed by both these members, and folding under a specified width of the margin of the adhesive tape toward the adhesive surface side. Accordingly, when the adhesive tape is pulled out, it comes into contact with and is pressed by the adhesive-surface-side member and, therefore, the adhesive surface of the adhesive tape sometimes becomes stuck to the adhesive-surface-side member, making it difficult to pull out the adhesive tape, and the adhesive tape can no longer be pulled out smoothly.

The present invention aims to improve the conventional adhesive tape cutters described above. It is the object of this invention to provide an adhesive tape cutter that can automatically form a tab for making it easier to later peel off the adhesive tape attached an object, and that can, when pulling out the adhesive tape, prevent the adhesive surface of the adhesive tape from becoming stuck to components facing the adhesive surface of the tape, thereby enabling a user to pull out the adhesive tape smoothly.

In order to achieve the above-described object, this invention provides an adhesive tape cutter comprising: a tape-supporting member for supporting a wound body of adhesive tape made by winding the adhesive tape, one side of which is an adhesive surface, in a roll, in such a manner that the wound body of adhesive tape can rotate; a cutting member for cutting the adhesive tape drawn from the wound body of adhesive tape supported by the tape-supporting member; and an overlapping-area-forming mechanism located between the tape-supporting member and the cutting member to form an overlapping area of the adhesive tape, along at least one margin in its lengthwise direction, said overlapping area made by folding under a margin of a specified width of the adhesive tape toward the adhesive surface side; wherein the overlapping-area-forming mechanism comprises: a first support member located near an adhesive-tape-unwinding position of the wound body of adhesive tape, that supports a non-adhesive surface of the adhesive tape; a fold-starting member that is located downstream of the first support member, supports the adhesive surface of the adhesive tape except for a specified folding width along a margin of the adhesive tape, and folds the folding width area; a main folding member that is located downstream of the fold-starting member and folds under, at an acute angle, the area of the adhesive tape folded by the fold-starting member; and an attaching member that is located opposite the main folding member, supports the non-adhesive surface of the adhesive tape, and presses and attaches the area folded under by the main folding member to the adhesive surface of the adhesive tape.

In the adhesive tape cutter having the above-described structure, the fold-starting member supports (or is in contact with) the adhesive surface of the adhesive tape when the overlapping area is formed on the adhesive tape drawn from the wound body of adhesive tape supported by the tape-supporting member in a rotatable manner. Since this adhesive tape cutter has no member (such as a roller) for pressing the adhesive tape hard against the fold-starting member, at a position on the other side of the adhesive tape opposite the fold-starting member, the adhesive surface of the adhesive tape does not become stuck fast to the surface of the fold-starting member. Therefore, it is possible to avoid the conventional problem of the adhesive surface of the adhesive tape attaching to the surface of the fold-starting member. Moreover, the non-adhesive surface of the adhesive tape comes into contact with the first support member and the attaching member. Accordingly, little power is required in order to draw the adhesive tape from the wound body of adhesive tape, thereby making it possible to unwind the adhesive tape smoothly.

The adhesive tape cutter of this invention can further comprise a second support member located downstream of the attaching member, that supports the non-adhesive surface of the adhesive tape. In addition to the above-described advantageous effects, because of the existence of the second support member, the adhesive tape can reach the cutting member in a more stable state.

Moreover, in the adhesive tape cutter of this invention, it is possible to form protrusions and indentations on the surface of the fold-starting member. This constitution makes it possible to reduce the surface area of the fold-starting member (the contact area) that comes into contact with the adhesive surface of the adhesive tape. Accordingly, much less power is required to draw the adhesive tape from the wound body of adhesive tape, thereby making it possible to unwind the adhesive tape more smoothly.

The first support member, the fold-starting member and the attaching member can be roller members located in a rotatable manner so that they guide the adhesive tape from upstream to downstream. The second support member can also be a roller member located in a rotatable manner so as to guide the adhesive tape from upstream to downstream.

Moreover, in the adhesive tape cutter of this invention, a controlling member for controlling the position of the adhesive tape can be placed at the end of the fold-starting member on the side opposite the margin where the overlapping area of the adhesive tape is formed. The existence of this controlling member makes it possible to fold the adhesive tape more stably and with certainty.

It is also possible to structure the adhesive tape cutter of this invention in the following manner: the distance between the controlling member of the fold-starting member and a contact part of the main folding member that comes into contact with the margin side of the overlapping area of the adhesive tape being shorter than the width of the adhesive tape that forms the wound body of adhesive tape. This structure makes it possible to fold the adhesive tape more stably and with certainty.

Moreover, in the adhesive tape cutter of this invention, a controlling member for controlling the position of the adhesive tape can be placed at the end of the second support member on the side opposite the margin where the overlapping area of the adhesive tape is formed. The existence of this controlling member makes it possible to fold the adhesive tape more stably and with certainty.

It is also possible to structure the adhesive tape cutter of this invention in the following manner: the distance between the controlling member of the second support member and the contact part of the main folding member that comes into contact with the margin side of the overlapping area of the adhesive tape being shorter than the width of the adhesive tape that forms the wound body of adhesive tape. This structure makes it possible to fold the adhesive tape more stably and with certainty.

The main folding member can have a pressing member capable of pressing only part of the adhesive tape, including the area folded by the fold-starting member. Because of the constitution of this main folding member, it is possible to reduce the area of the main folding member that comes into contact with the adhesive surface of the adhesive tape. Accordingly, much less power is required to draw the adhesive tape from the wound body of adhesive tape, thereby making it possible to unwind the adhesive tape more smoothly.

Moreover, the main folding member can comprise: a first folding guide member that comes into contact with the non-adhesive surface of the adhesive tape folded by the fold-starting member and guides the adhesive tape so that the fold angle of the adhesive tape becomes more acute; and a second folding guide member for guiding and folding the adhesive tape, which has been folded by the first folding guide member, completely on to itself. Because of the constitution of this main folding member, it is possible to fold the adhesive tape under more stably and with certainty.

Furthermore, this invention provides an adhesive tape for the above-described adhesive tape cutter, wherein a marked line is formed along the overlapping area in the vicinity of the area to become the overlapping area formed by the overlapping-area-forming mechanism of the adhesive tape cutter.

With the adhesive tape having the above-described structure for the adhesive tape cutter, it is possible to use the marked line to indicate the position of the overlapping area when the adhesive tape is attached to the object. Accordingly, when a user intends to remove the adhesive tape from the object, he/she can easily locate the tab (i.e. the overlapping area) to peel off the adhesive tape and can thereby remove the adhesive tape from the object with greater ease.

Moreover, the marked line can include at least one of: marks, letters, or pictures to indicate the existence of the overlapping area.

Therefore, when the overlapping area is formed on the adhesive tape drawn from the wound body of adhesive tape supported by the tape-supporting member in a manner such that the wound body of adhesive tape can rotate, the adhesive tape cutter of this invention makes it possible to draw the adhesive tape from the wound body of adhesive tape with little power, and without having the adhesive surface of the adhesive tape stuck fast to the surfaces of the components that constitute the overlapping-area-forming mechanism. As a result, it is possible to unwind the adhesive tape smoothly and to improve workability in attaching the adhesive tape to an object.

### DESCRIPTION OF DRAWINGS

FIG. 1 is a perspective view of an adhesive tape cutter according to a preferred embodiment of this invention.

FIG. 2 is a left side view of the adhesive tape cutter in FIG. 1.

FIG. 3 is a right side view of the adhesive tape cutter in FIG. 1.

FIG. 4 is a plan view of the adhesive tape cutter in FIG. 1.

FIG. 5 is a front view of the adhesive tape cutter in FIG. 1.

FIG. 6 is a rear view of the adhesive tape cutter in FIG. 1.

FIG. 7 is a bottom view of the adhesive tape cutter in FIG. 1.

FIG. 8 is a fragmentary enlarged perspective view of the overlapping-area-forming mechanism of the adhesive tape cutter in FIG. 1.

FIG. 9 is a fragmentary enlarged perspective view of the overlapping-area-forming mechanism of the adhesive tape cutter in FIG. 1.

FIG. 10 shows the state in which a wound body of adhesive tape is mounted on the adhesive tape cutter in FIG. 2.

FIG. 11 shows the state in which the wound body of adhesive tape is mounted on the adhesive tape cutter in FIG. 4.

FIG. 12 is a plan view of the adhesive tape used for the adhesive tape cutter according to the preferred embodiment of this invention.

### DETAILED DESCRIPTION

The adhesive tape cutter according to a preferred embodiment of the present invention is described below with reference to the attached drawings. The embodiment is for the purpose of illustration only, and the invention is not limited only to the one embodiment. Accordingly, this invention can be utilised in various ways unless the utilisations depart from the gist of the invention.

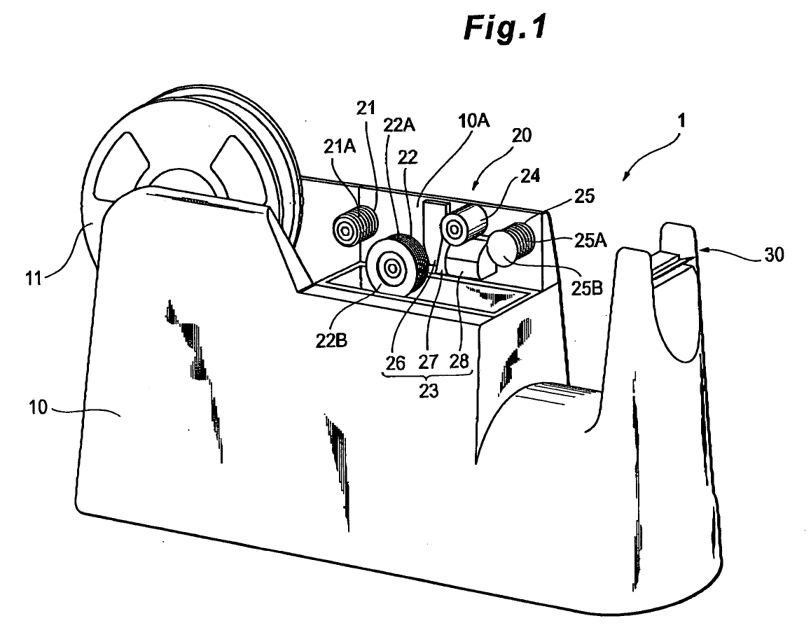

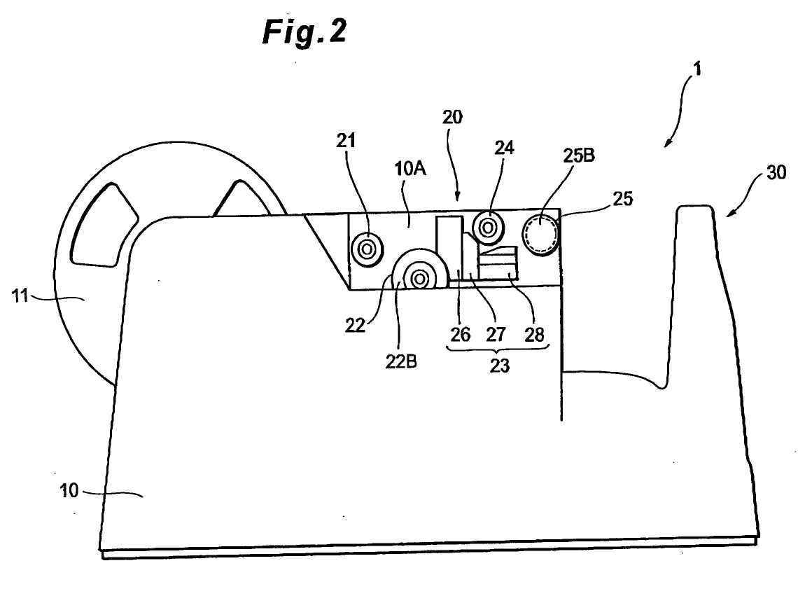

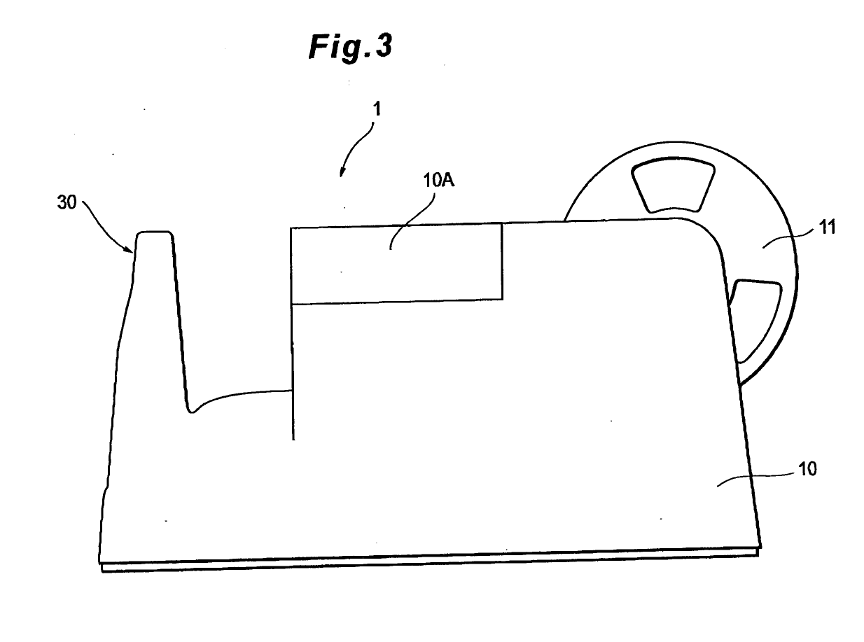

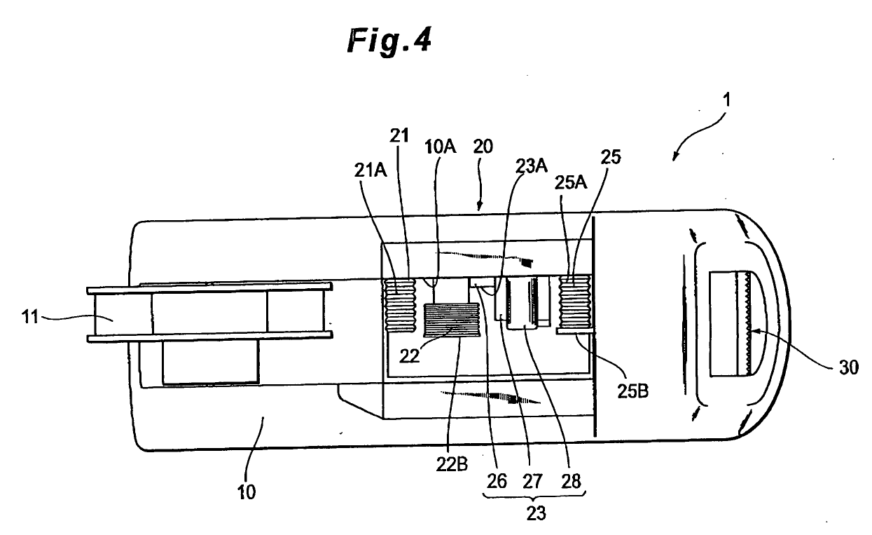

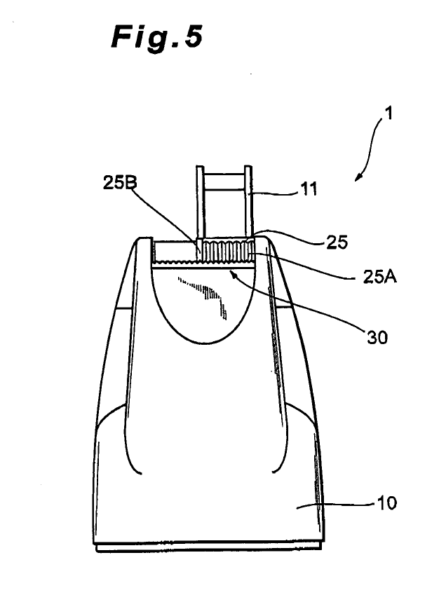

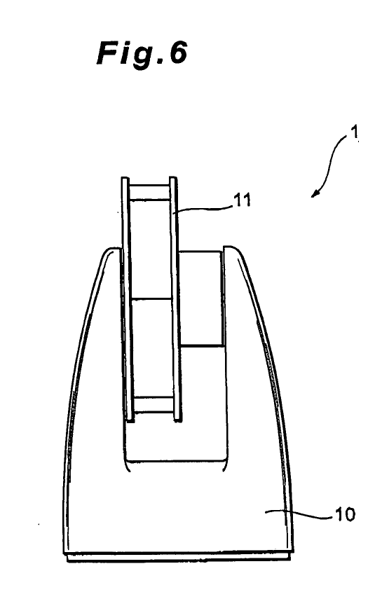

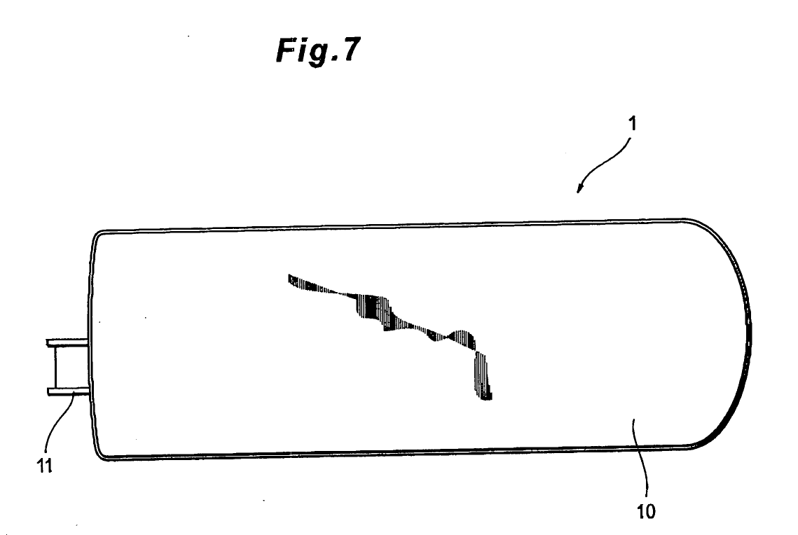

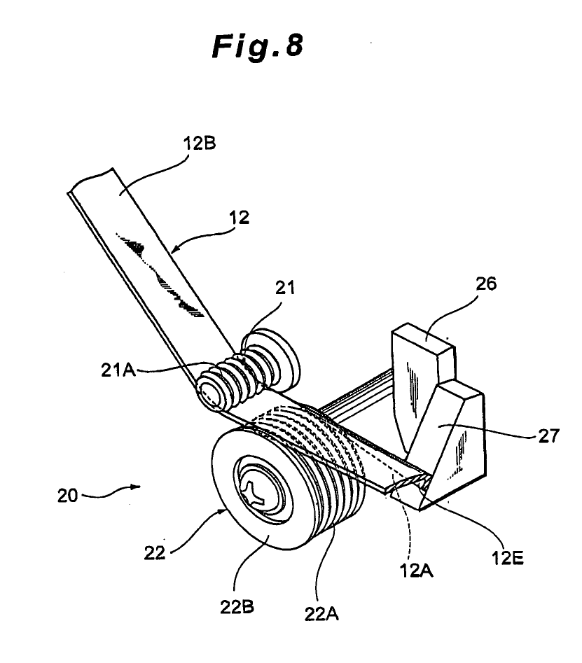

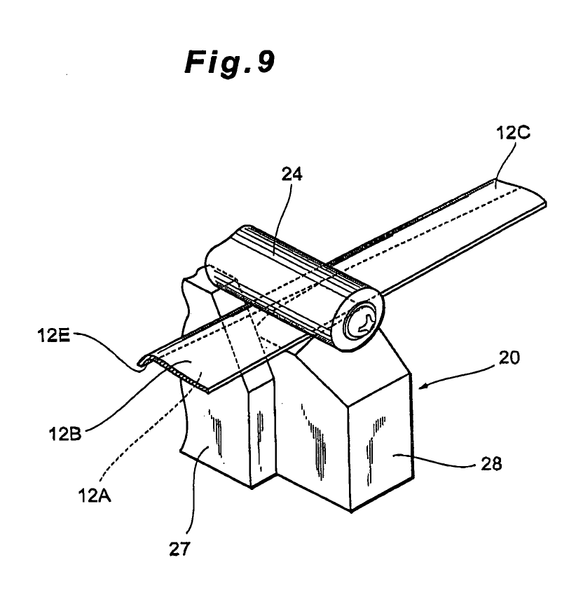

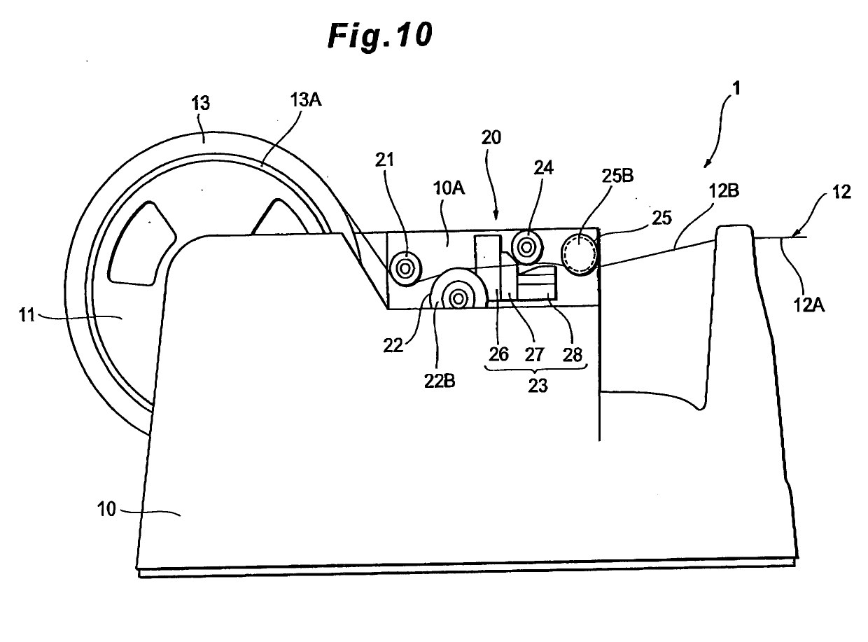

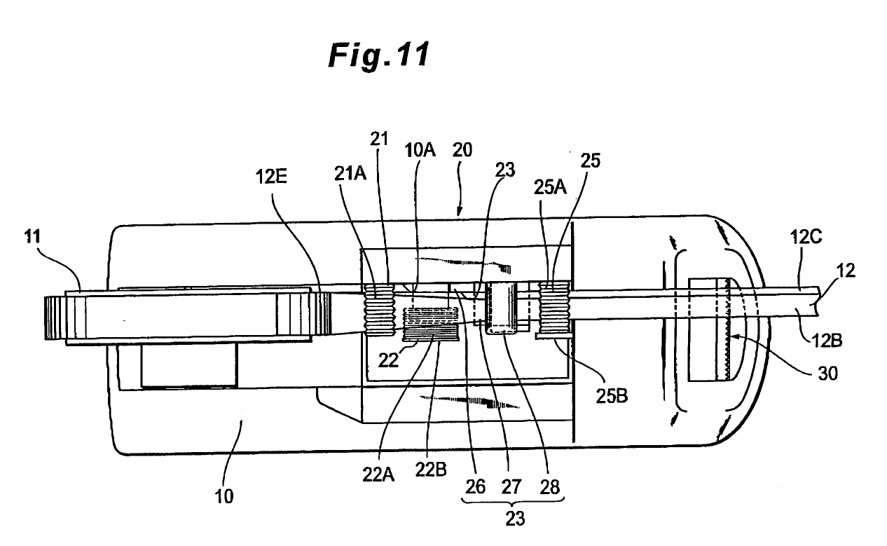

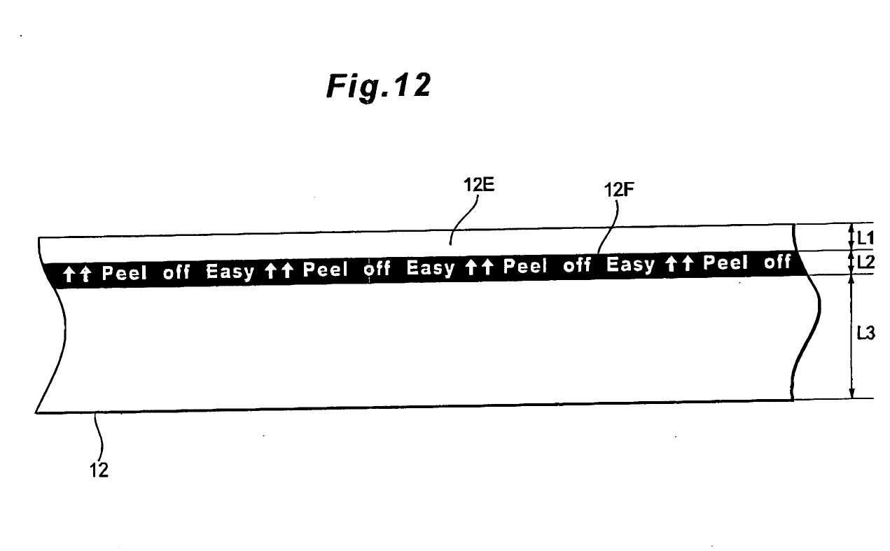

FIG. 1 is a perspective view of the adhesive tape cutter according to the preferred embodiment of this invention. FIG. 2 is a left side view of the adhesive tape cutter in FIG. 1. FIG. 3 is a right side view of the adhesive tape cutter in FIG. 1. FIG. 4 is a plan view of the adhesive tape cutter in FIG. 1. FIG. 5 is a front view of the adhesive tape cutter in FIG. 1. FIG. 6 is a rear view of the adhesive tape cutter in FIG. 1. FIG. 7 is a bottom view of the adhesive tape cutter in FIG. 1. FIGS. 8 and 9 are fragmentary enlarged perspective views of the overlapping-area-forming mechanism of the adhesive tape cutter in FIG. 1. FIG. 10 shows the state in which the wound body of adhesive tape is mounted on the adhesive tape cutter in FIG. 2. FIG. 11 shows the state in which the wound body of adhesive tape is mounted on the adhesive tape cutter in FIG. 4. FIG. 12 is a plan view of the adhesive tape used for the adhesive tape cutter according to the preferred embodiment of this invention.

As shown in FIGS. 1 through 11, an adhesive tape cutter 1 according to this embodiment includes: a tape base 10; a tape-supporting member 11 that is located at one end of the tape base 10 and supports a wound body of adhesive tape 13 in such a manner that the wound body 13 can rotate; a cutting member 30 located at the other end of the tape base 10; and an overlapping-area-forming mechanism 20 located between the tape-supporting member 11 of the tape base 10 and the cutting member 30.

As shown in FIG. 10, the adhesive-tape-wound body 13 which is set on the adhesive tape cutter 1 according to this embodiment is formed by winding, in a roll around a roll core 13A, the adhesive tape 12 whose one side is an adhesive surface 12A and whose other side is a non-adhesive surface 12B.

As shown in FIG. 12, the adhesive tape 12 has a continuous marked line 12F of width L₂ running in the lengthwise direction of the adhesive tape 12 at a position distance L₁ from one edge of the adhesive tape 12. An area extending from one edge of the adhesive tape 12 to the marked line 12F (an area defined by distance L₁) is margin 12E of the adhesive tape 2. The words “Peel off Easy” are indicated on this marked line 12F. Reference numeral L₃ in FIG. 12 indicates the distance from the marked line 12F to the other edge of the adhesive tape 12 opposite the above-mentioned margin 12E.

When the adhesive tape cutter 1 according to this embodiment, described later in detail, folds the margin 12E of this adhesive tape 12 under and forms an overlapping area 12C (see FIGS. 9 and 11), the marked line 12F becomes adjacent to the overlapping area 12C.

A roll core 13A of the wound body of adhesive tape 13 is fit into the tape-supporting member 11, which has a disk-like shape and is rotatable on the tape base 10. This tape-supporting member 11 can be freely detached from and attached to the tape base 10, and is mounted on the tape base 10 in the state where the wound body of adhesive tape 13 is set on the tape-supporting member 11 in such a manner that the adhesive surface 12A of the adhesive tape will face downward when the adhesive tape 12 is pulled out.

The overlapping-area-forming mechanism 20 comprises: a first support roll 21 that is rotatable and located near an adhesive-tape-unwinding position of the wound body of adhesive tape 13, and supports the non-adhesive surface 12B of the adhesive tape 12; a fold-starting roll 22 that is rotatable and located downstream of the first support roll 21, supports the adhesive surface 12A of the adhesive tape 12 except for a specified folding width along the margin 12E of the adhesive tape 12 (see FIGS. 11 and 12), and folds the folding width area of the margin 12E of the adhesive tape 12; a main folding member 23 that is located downstream of the fold-starting roll 22 and folds under, at an acute angle, the area of the adhesive tape 12 folded by the fold-starting roll 22; an attaching roll 24 that is rotatable and located opposite the main folding member 23, supports the non-adhesive surface 12B of the adhesive tape 12, and presses and attaches the margin 12E folded under by the main folding member 23 to the adhesive surface 12A of the adhesive tape 12; and a second support roll 25 that is rotatable and located downstream of the attaching roll 24, and supports the non-adhesive surface 12B of the adhesive tape 12.

The first support roll 21 is cylindrical in shape and one of its ends is attached to a side wall 10A of the tape base 10 in such a manner that the first support roll 21 can rotate. A plurality of grooves 21A is formed circumferentially on the surface of the first support roll 21.

The fold-starting roll 22 is cylindrical in shape, having a comparatively larger diameter than that of the first support roll 21, and one end of the fold-starting roll 22 is attached in a rotatable manner to the side wall 10A of the tape base 10. A plurality of grooves 22A is formed circumferentially on the surface of the fold-starting roll 22. Moreover, a flange 22B is formed at the other end of the fold-starting roll 22. The distance between this flange 22B and a contact part 23A (see FIG. 4) of the main folding member 23, described later in detail, that comes into contact with the margin 12E of the adhesive tape 12 where the overlapping area 12C (see FIGS. 9 and 11) is to be formed, is set to be shorter than the width of the adhesive tape 12. Therefore, the flange 22B plays the role of a controlling member for moving the position of the adhesive tape 12 toward the side wall 10A of the tape base 10.

The main folding member 23 comprises the following components listed in order from upstream to downstream: a fold-angle-maintaining member 26 that comes into contact with the non-adhesive surface 12B of the margin 12E of the adhesive tape 12 folded by the fold-starting roll 22 and maintains the fold angle of the margin 12E; a first folding guide member 27 that is connected to the fold-angle-maintaining member 26 and guides the adhesive tape 12 so that the fold angle of the margin 12E of the adhesive tape 12 becomes approximately 120 degrees (that is, the fold angle on the adhesive surface 12A side becomes an acute angle of approximately 60 degrees); and a second folding guide member 28 that is connected to the first folding guide member 27 and comes into contact with and folds under the non-adhesive surface 12B of the margin 12E of the adhesive tape 12, to fold the adhesive tape 12 completely onto itself.

The fold-angle-maintaining member 26 projects from the side wall 10A of the tape base 10, and this projection makes it possible to come into contact with the non-adhesive surface 12B of the adhesive tape 12 along the margin 12E as particularly shown in FIG. 8.

The first folding guide member 27 is inclined with its lower part protruding farther than its upper part from the side wall 10A of the tape base 10. The fold angle of the margin 12E of the adhesive tape 12 is determined according to this inclination angle. (As stated above, the fold angle in this embodiment is approximately 120 degrees.)

The second folding guide member 28 protrudes farther from the side wall 10A than the first folding guide member 27 does. The area of the second folding guide member 28 where the folded margin 12E of the adhesive tape 12 closer to the side wall 10A of the tape base 10 passes is structured to provide a narrow space between the second folding guide member 28 and the attaching roll 24, described below in detail. This narrow space serves to make the second folding guide member 28 come into contact with the non-adhesive surface 12B of the margin 12E of the adhesive tape 12 and fold the margin 12E under, to fold the adhesive tape 12 completely onto itself.

The attaching roll 24 is cylindrical in shape and one of its ends is attached in a rotatable manner to the side wall 10A of the tape base 10. This attaching roll 24 is located near, above and opposite the second folding guide member 28 of the main folding member 23, supports the non-adhesive surface 12B of the adhesive tape 12, and presses and attaches the margin 12E of the adhesive tape 12 folded under by the main folding member 23 to the adhesive surface 12A.

The second support roll 25 is cylindrical in shape and one of its ends is attached in a rotatable manner to the side wall 10A of the tape base 10. A plurality of grooves 25A is formed circumferentially on the surface of the second support roll 25. Moreover, a flange 25B is formed at the other end of the second support roll 25. The distance between this flange 25B and the contact part 23A (see FIG. 4) of the main folding member 23 that comes into contact with the margin of the adhesive tape 12 where the overlapping area 12C (see FIGS. 9 and 11) is formed, is set to be shorter than the width of the adhesive tape 12. Therefore, the flange 25B plays the role of a controlling member for controlling the position of the adhesive tape 12.

The cutting member 30 is fixed on the tape base 10 and set approximately perpendicular to the unwinding direction of the adhesive tape 12 on which the overlapping area 12C is formed.

Detailed actions of the adhesive tape cutter 1 according to this embodiment are described below.

The wound body of adhesive tape 13 is first set on the tape-supporting member 11, and this tape-supporting member 11 with the wound body of adhesive 13 is attached to the tape base 10. At this moment, the tape-supporting member 11 is set on the tape base 10 in such a manner that the adhesive surface 12A of the adhesive tape 12 will face downward when the adhesive tape 12 is pulled out.

The adhesive tape 12 is then set as follows: the non-adhesive surface 12B of the adhesive tape 12 is placed beneath the first support roll 21 and the adhesive surface 12A of the adhesive tape 12 goes above the fold-starting roll 22; the adhesive tape 12 is then inserted between the main folding member 23 and the attaching roll 24; subsequently, the non-adhesive surface 12B of the adhesive tape 12 goes beneath the second support roll 25; and the pulled-out top end of the adhesive tape 12 finally reaches the cutting member 30.

When the adhesive tape 12 is pulled out in the above-described state, its non-adhesive surface 12B first comes into contact with the first support roll 21 and then is guided toward the area above the fold-starting roll 22. At this fold-starting roll 22, its flange 22B engages with the edge of the adhesive tape 12 furthest away from the side wall 10A and thereby controls the position of the adhesive tape 12. This control causes the margin 12E of the adhesive tape 12 closer to the side wall 10A to become free from the end of the fold-starting roll 22 closer to the side wall 10A. In other words, the fold-starting roll 22 supports the adhesive surface 12A of the adhesive tape 12 except for a specified folding width along the margin 12E of the adhesive tape 12, and thereby folds the folding width area of the adhesive tape 12. (See FIG. 8.)

Subsequently, after the adhesive tape 12 has passed the fold-starting roll 22, the non-adhesive surface 12B of the margin 12E comes into contact with the fold-angle-maintaining member 26 of the main folding member 23. While the fold angle of the margin 12E folded by the fold-starting roll 22 is maintained, the adhesive tape 12 reaches the first folding guide member 27. This first folding guide member 27 further folds the margin 12E of the adhesive tape 12 so as to cause the fold angle of the margin 12E of the adhesive tape 12 to become approximately 120 degrees. (See FIG. 8.)

The adhesive tape 12 is then inserted between the second folding guide member and the attaching roll 24, thereby folding the margin 12E of the adhesive tape 12 under to fold the adhesive tape 12 completely onto itself, and pasting the adhesive surfaces 12A of this area together to form the overlapping area 12C. (See FIG. 9.)

Subsequently, the adhesive tape 12 with the overlapping area 12C passes the second support roll 25 and reaches the cutting member 30.

In forming the overlapping area 12C along the margin 12E of the adhesive tape 12, the adhesive surface 12A of the adhesive tape 12 comes into contact with the surface of the fold-starting roll 22. However, because of a plurality of grooves 22A in the surface of the fold-starting roll 22, its contact area with the adhesive surface 12A is small and it is thereby possible to reduce the power necessary to draw the adhesive tape 12 from the adhesive-tape-wound body 13. Moreover, there is no member (such as a roller) pressing the adhesive tape 12 hard against the fold-starting roll 22. Therefore, the adhesive surface 12A of the adhesive tape 12 is not firmly attached to the surface of the fold-starting roll 22, thereby making it possible to unwind the adhesive tape 12 smoothly.

After a desired length of the adhesive tape 12 with the overlapping area 12C is pulled out, the cutting member 30 is used to cut the adhesive tape 12, and the cut-off tape 12 is then attached to an object.

Moreover, as stated above, it is possible to automatically form the overlapping area 12C when pulling out the adhesive tape 12.

As the adhesive tape 12 on which the overlapping area 12C is formed is attached to the object by the above-described steps, this overlapping area 12C serves as a tab that makes it easier to peel off the adhesive tape 12, and it is thereby possible to easily peel off the adhesive tape 12 from the object. Since there is the marked line 12F near this tab (i.e., the overlapping area 12C), it is possible to locate the tab easily and to conduct the binding removal process more simply.

1. An adhesive tape cutter comprising:
a tape-supporting member for supporting a wound body of adhesive tape made by winding adhesive tape, one side of which is an adhesive surface, in a roll, in such a manner that the wound body of adhesive tape can rotate;
a cutting member for cutting the adhesive tape drawn from the wound body of adhesive tape supported by the tape-supporting member; and
an overlapping-area-forming mechanism located between the tape-supporting member and the cutting member to form an overlapping area of the adhesive tape, along at least one margin in its lengthwise direction, said overlapping area made by folding under a margin of a specified width of the adhesive tape toward the adhesive surface side;
wherein the overlapping-area-forming mechanism comprises:
a first support member located near an adhesive-tape-unwinding position of the wound body of adhesive tape, that supports a non-adhesive surface of the adhesive tape;
a fold-starting member that is located downstream of the first support member, supports the adhesive surface of the adhesive tape except for a specified folding width along the margin of the adhesive tape, and folds the folding width area;
a main folding member that is located downstream of the fold-starting member and folds under, at an acute angle, the area of the adhesive tape folded by the fold-starting member; and
an attaching member that is located opposite the main folding member, supports the non-adhesive surface of the adhesive tape, and presses and attaches the area folded under by the main folding member to the adhesive surface of the adhesive tape.

2. The adhesive tape cutter according to claim 1, further comprising a second support member located downstream of the attaching member, that supports the non-adhesive surface of the adhesive tape.

3. The adhesive tape cutter according to claim 1, wherein the surface of the fold-starting member has protrusions and indentations.

4. The adhesive tape cutter according to claim 1, wherein the first support member, the fold-starting member and the attaching member are roller members located in a rotatable manner so that they guide the adhesive tape from upstream to downstream.

5. The adhesive tape cutter according to claim 2, wherein the second support member is a roller member located in a rotatable manner so as to guide the adhesive tape from upstream to downstream.

6. The adhesive tape cutter according to claim 1, wherein a controlling member for controlling the position of the adhesive tape is placed at the end of the fold-starting member on the side opposite the margin where the overlapping area of the adhesive tape is formed.

7. The adhesive tape cutter according to claim 6, wherein the distance between the controlling member of the fold-starting member and a contact part of the main folding member that comes into contact with the margin side of the overlapping area of the adhesive tape is shorter than the width of the adhesive tape that forms the wound body of adhesive tape.

8. The adhesive tape cutter according to claim 1, wherein a controlling member for controlling the position of the adhesive tape is placed at the end of the second support member on the side opposite the margin where the overlapping area of the adhesive tape is formed.

9. The adhesive tape cutter according to claim 8, wherein the distance between the controlling member of the second support member and a contact part of the main folding member that comes into contact with the margin side of the overlapping area of the adhesive tape is shorter than the width of the adhesive tape that forms the wound body of adhesive tape.

10. The adhesive tape cutter according to claim 1, wherein the main folding member has a pressing member capable of pressing only part of the adhesive tape, including the area folded by the fold-starting member.

11. The adhesive tape cutter according to claim 1, wherein the main folding member comprises:
a first folding guide member that comes into contact with the non-adhesive surface of the adhesive tape folded by the fold-starting member and guides the adhesive tape so that the fold angle of the adhesive tape becomes more acute; and
a second folding guide member for guiding and folding the adhesive tape, which has been folded by the first folding guide member, completely on to itself.

12. An adhesive tape for the adhesive tape cutter according to claim 1, wherein a marked line is formed along the overlapping area in the vicinity of the area to become the overlapping area formed by the overlapping-area-forming mechanism of the adhesive tape cutter.

13. The adhesive tape for the adhesive binding tape cutter according to claim 12, wherein the marked line includes at least one of: marks, letters, or pictures to indicate the existence of the overlapping area.

14. The adhesive tape cutter according to claim 2, wherein the surface of the fold-starting member has protrusions and indentations.
